(19) United States
(12) Patent Application Publication
(10) Pub. No.: US 2010/0020848 A1
(43) Pub. Date: Jan. 28, 2010

(54) PROTECTIVE TUBES FOR THERMOCOUPLES

(76) Inventors: Mohamed Nazmy, Fislisbach (CH); Andreas Künzler, Baden (CH); Giuseppe Bandiera, Ehrendingen (CH); Hanspeter Zinn, Rütihof (CH)

Correspondence Address: CERMAK KENEALY VAIDYA & NAKAJIMA LLP, 515 E. BRADDOCK RD, ALEXANDRIA, VA, 22314, US

(21) Appl. No.: 12/504,003

(22) Filed: Jul. 16, 2009

(30) Foreign Application Priority Data
Jul. 25, 2008 (CH) 01173/08

(51) Int. Cl. G01K 7/02; B32B 1/08; B32B 15/01

(52) U.S. Cl. 374/179; 428/544; 374/E07.004; 374/208

(57) ABSTRACT

Protective tubes for thermocouples exposed to oxidizing atmospheres at temperatures in the region of approximately 1100° C. are produced from a single-crystal nickel-based superalloy, preferably from an alloy having the following chemical composition (in % by weight): 7.7-8.3 Cr, 5.0-5.25 Co, 2.0-2.1 Mo, 7.8-8.3 W, 5.8-6.1 Ta, 4.9-5.1 Al, 1.3-1.4 Ti, 0.11-0.15 Si, 0.11-0.15 Hf, 200-750 ppm C, 50-400 ppm B, remainder nickel and unavoidable impurities. Protective tubes of this type exhibit good strength and good oxidation resistance under severe stress conditions.

This application claims priority under 35 U.S.C. §119 to Swiss application no. 01173/08, filed 25 Jul. 2008, the entirety of which is incorporated by reference herein.

### BACKGROUND

1. Field of Endeavor

The invention relates to protective tubes for thermocouples exposed to oxidizing atmospheres at very high temperatures in the region of approximately 1100° C. Severe stress conditions of this type occur, for example, when measuring the temperature in gas turbines.

2. Brief Description of the Related Art

The type GT24/GT26 gas turbines of ALSTOM, which are known from the prior art, operate on the basis of the sequential combustion principle. This involves the hot gases provided in a first combustion chamber acting on a first turbine, with the exhaust gases which flow out of this first turbine then being prepared in a second combustion chamber to re-form hot gases which then act on a second turbine. The second combustion chamber is designed for spontaneous ignition, i.e., the temperature of the exhaust gases from the first turbine has to allow spontaneous ignition to take place in conjunction with the fuel injected into said chamber. For this reason, it is necessary to monitor and measure the temperature of the gas flow. For this purpose, thermocouples provided with protective tubes (sleeves for thermocouples) are used, these protective tubes consisting of the oxide-dispersion-strengthened (ODS) material PM 2000.

PM 2000 is a ferritic, iron-based ODS alloy having the following nominal chemical composition (in % by weight): 20.0 Cr, 5.5 Al, 0.5 Ti, 0.5 Y₂O₃ (addition in the form of an oxide dispersion), remainder Fe.

The operating temperatures of this metallic material reach up to approximately 1350° C. It has potential properties that are more typical of ceramic materials, such as very high creep rupture strengths at very high temperatures and also outstanding high-temperature oxidation resistance as a result of the formation of a protective Al₂O₃ film, as well as high resistance to sulfidizing and steam oxidation. The material has highly pronounced directional-dependent properties. In tubes, for example, the creep strength in the transverse direction is only approximately 50% of the creep strength in the longitudinal direction.

ODS alloys of this type (in addition to the described alloy PM 2000, mention should be made at this point of the alloy MA 956, for example) are produced by a powder metallurgy process, using mechanically alloyed powder mixtures that are compacted in a known manner, for example by extrusion or by hot isostatic pressing. The compact is subsequently highly plastically deformed, usually by hot rolling, and subjected to a recrystallization annealing treatment. This production method, but also the material compositions described, disadvantageously mean, inter alia, that these alloys are very expensive and have anisotropic properties.

It is furthermore known prior art to use the known nickel-based high temperature alloy Inconel 600 (material no. 2.4816, NiCr15Fe) as the sleeve material in conjunction with thermocouples for use at relatively high temperatures of up to approximately 1050° C., the alloy having the following chemical composition (in % by weight): max. 0.10 C, max. 0.50 Si, max. 1.00 Mn, max. 0.02 P, max. 0.015 S, 14.00-17.00 Cr, 6.00-10.00 Fe, max. 0.30 Ti, max. 0.50 Cu, max. 0.30 Al, remainder Ni. Although this polycrystalline material has good oxidation resistance at temperatures up to approximately 1050° C. and good resistance to stress corrosion cracking owing to the high nickel content, the creep rupture strength is unsatisfactory. Unfortunately, this also applies to the resistance of this polycrystalline material to thermal shocks.

In order to produce single-crystal components in gas turbines, recent years have seen the development of special nickel-based superalloys which withstand the severe stress conditions of modern gas turbines. To date, these single-crystal nickel-based superalloys have predominantly been used for producing gas-turbine blades.

By way of example, EP 1 359 231 B1 discloses a nickel-based alloy which is distinguished by good castability and high oxidation resistance and is suitable for producing single-crystal components or directionally solidified components in gas turbines, for example gas-turbine blades. This alloy has the following chemical composition (in % by weight): 7.7-8.3 Cr, 5.0-5.25 Co, 2.0-2.1 Mo, 7.8-8.3 W, 5.8-6.1 Ta, 4.9-5.1 Al, 1.3-1.4 Ti, 0.11-0.15 Si, 0.11-0.15 Hf, 200-750 ppm C, 50-400 ppm B, remainder nickel and unavoidable impurities.

### SUMMARY

One of numerous aspects of the present invention relates to a material suitable for producing protective tubes for thermocouples that can be used without any problems in an oxidizing atmosphere in gas turbines at extremely high temperatures of approximately 1200° C. At approximately 1200° C., the protective tubes should firstly have a sufficient oxidation resistance which is as high as possible, and secondly good creep rupture strength and high resistance to thermal shocks.

According to another aspect of the present invention, protective tubes are produced from a single-crystal nickel-based superalloy known from the prior art. On the one hand, the protective tubes for thermocouples which are produced from these alloys have a sufficient creep rupture strength at the high operating temperatures, and on the other hand they have good resistance to thermal shocks since, compared to polycrystalline materials, grain boundaries which act as imperfections and starting points for cracks are not present in the single-crystal alloys used. This is a decisive factor when these tubes are used in gas turbines since, when the gas turbines are shut down, for example, large temperature differences occur there as compared with continuous operation of the plant.

The protective tubes of the thermocouples preferably are formed of an alloy having the following chemical composition (in % by weight): 7.7-8.3 Cr, 5.0-5.25 Co, 2.0-2.1 Mo, 7.8-8.3 W, 5.8-6.1 Ta, 4.9-5.1 Al, 1.3-1.4 Ti, 0.11-0.15 Si, 0.11-0.15 Hf, 200-750 ppm C, 50-400 ppm B, remainder nickel and unavoidable impurities, particularly preferably of an alloy having the following chemical composition (in % by weight): 7.7 Cr, 5.1 Co, 2.0 Mo, 7.8 W, 5.8 Ta, 5.0 Al, 1.4 Ti, 0.12 Si, 0.12 Hf, 200 ppm C, 50 ppm B, remainder nickel and unavoidable impurities. This alloy, which is known from EP 1 359 231 B1, is distinguished by good oxidation resistance in conjunction with very good strength at the high temperatures specified.

### BRIEF DESCRIPTION OF THE DRAWINGS

Exemplary embodiments of the invention are illustrated in the drawings, in which:

FIG. 1: shows a section through a protective tube for thermocouples;

FIG. 2: shows a graph plotting the yield strength as a function of the temperature for various alloys used as the material for the protective tubes, and

FIG. 3: shows a graph plotting the change in the quasi-isothermal oxidation weight at 1050° C. as a function of time for various alloys used as the material for the protective tubes.

### DETAILED DESCRIPTION OF EXEMPLARY EMBODIMENTS

The invention is explained in more detail below on the basis of exemplary embodiments and the drawing.

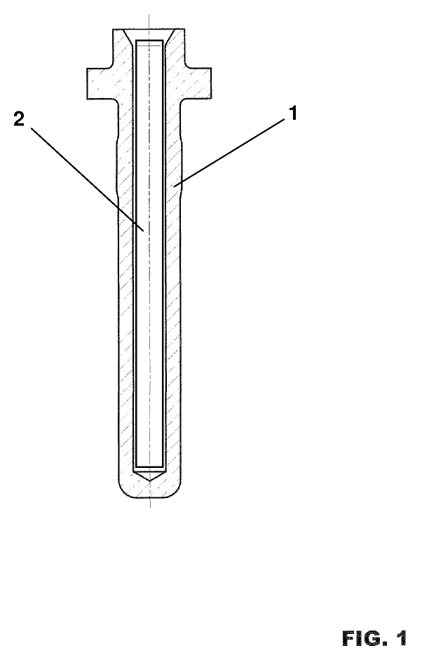

FIG. 1 schematically shows a section through a protective tube for thermocouples (sleeves for thermocouples), as is used by ALSTOM for measuring the temperature of the gas flow in gas turbines with sequential combustion. To date, protective tubes of this type have been produced by a powder metallurgy process from the ODS FeCrAl comparative alloy PM 2000 known from the prior art.

According to the invention, the protective tubes were produced from various single-crystal nickel-based superalloys and investigated with regard to the oxidation behavior and the mechanical properties at temperatures up to 1100° C.

Table 1 lists the respective chemical composition of the investigated alloys; the alloying constituents are specified in % by weight and, at points marked specifically, in ppm:

TABLE 1
Compositions of the investigated alloys for protective tubes

| Constituent | | | | | | | | | | | |
|---|---|---|---|---|---|---|---|---|---|---|---|
| Alloy | | | | | | | | | | | C |
| Designation | Ni | Cr | Al | Ta | Mo | Re | Co | W | Y | Hf | Other Const. |
| PWA1483 | Rem. | 12.8 | 3.6 | 4 | 1.9 | — | 9 | 3.8 | 0.1 | — | — |
| MK4HC | Rem. | 6.6 | 5.6 | 6.5 | 0.6 | 3 | 9 | 6 | 0.1 | 0.1 | 380 ppm |
| Alloy A | Rem. | 7.7 | 5.0 | 5.8 | 2.0 | — | 5.1 | 7.8 | — | 0.12 | 200 ppm |
| | | | | | | | | | | | 50 ppm B |
| | | | | | | | | | | | 0.12 Si |
| | | | | | | | | | | | 1.4 Ti |
| MA 956 | — | 20 | 4.5 | — | — | — | — | — | * | — | — |
| | | | | | | | | | | | 0.5 Ti |
| | | | | | | | | | | | Rem. Fe |
| PM 2000 | — | 20 | 5.5 | — | — | — | — | — | * | — | — |
| | | | | | | | | | | | 0.5 Ti |
| | | | | | | | | | | | Rem. Fe |

*Y₂O₃—Al₂O₃ (0.5 Y₂O₃)

FIG. 1 shows a section through a protective tube 1 for thermocouples 2 as is used by ALSTOM.

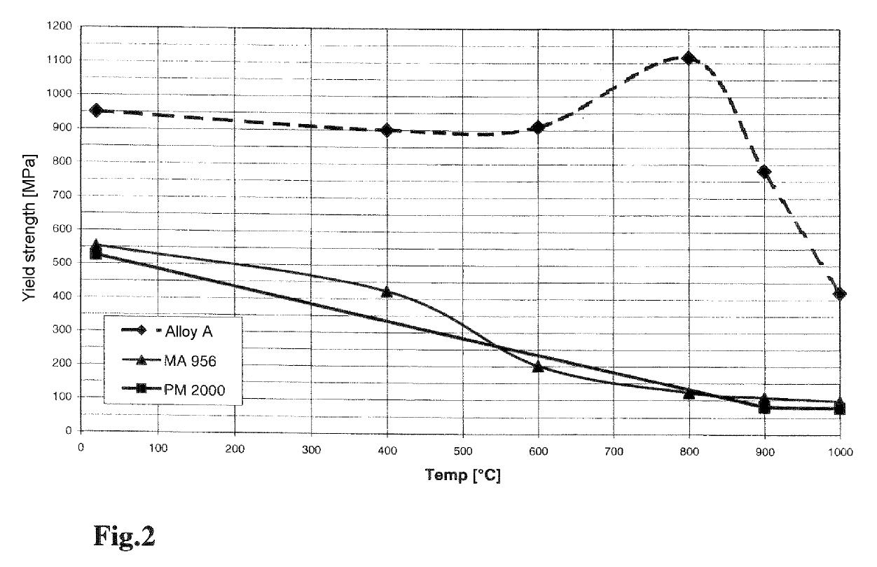

FIG. 2 illustrates the progression of the yield strength for various materials, which have been used for such protective tubes for thermocouples, as a function of the temperature. Throughout the temperature range investigated, from room temperature up to 1100° C., the yield strength of alloy A (single-crystal nickel-based superalloy) is significantly higher than that of the two iron-based ODS alloys (MA 956 and PM 2000). Whereas it is almost twice as high at room temperature, it is even approximately four times higher at 1000° C.

The single-crystal nickel-based superalloys also have very good resistance to thermal shocks since they have no grain boundaries which act as imperfections in the microstructure, and this is a major advantage for the intended use.

A tensile test for specimens of alloy A gave the following results:

At 950° C., the tensile strength is 830 MPa, whereas the yield strength is 624 MPa. The elongation is 28%. These mechanical properties are sufficient for withstanding the stresses of the gas flow in the gas turbine at 1050-1100° C.

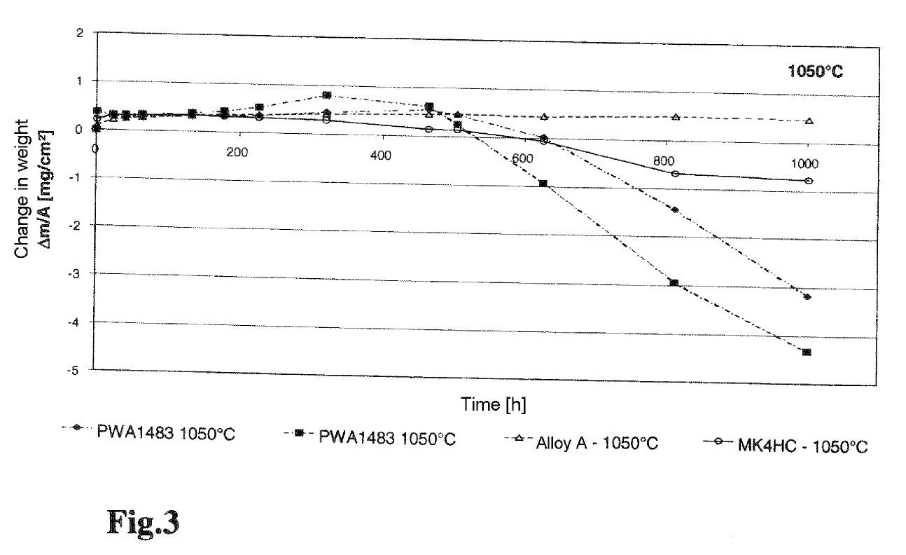

FIG. 3 shows a graph plotting the change in the quasi-isothermal oxidation weight at 1050° C. as a function of time for various alloys used as the material for the protective tubes. The graph shows the results for the single-crystal nickel-based superalloys PWA 1483, MK4HC and alloy A, which are known from the prior art, with age-hardening times of up to 1000 hours. FIG. 3 shows that alloy A experiences only a very minor change in weight over the entire period of 1000 hours at 1050° C., that is to say has very good oxidation resistance which is sufficient for the intended purpose, even though it is lower than that of the ODS alloys. After an age-hardening time of approximately 500 hours, the alloy PWA 1483 shows a marked drop in oxidation resistance, while the change in weight of the alloy MK4HC is still moderate even after approximately 600 hours.

In summary, it can be stated that protective tubes for thermocouples which are used for measuring the temperature in the gas flow of gas turbines with sequential combustion can be produced from known single-crystal nickel-based superalloys and entirely withstand the severe stress conditions at high temperatures with respect to creep rupture strength, resistance to thermal shocks and oxidation resistance. In particular, alloy A formed of (in % by weight) 7.7 Cr, 5.1 Co, 2.0 Mo, 7.8 W, 5.8 Ta, 5.0 Al, 1.4 Ti, 0.12 Si, 0.12 Hf, 200 ppm C, 50 ppm B, remainder nickel and unavoidable impurities, exhibits a very good combination of properties for this intended use. It can also be produced relatively easily since it can readily be cast.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A protective tube for thermocouples exposed to oxidizing atmospheres at temperatures in the region of approximately 1100° C., wherein the protective tube is formed from a single-crystal nickel-based superalloy.

2. The protective tube as claimed in claim 1, wherein the single-crystal nickel-based superalloy has the following chemical composition (in % by weight): 7.7-8.3 Cr, 5.0-5.25 Co, 2.0-2.1 Mo, 7.8-8.3 W, 5.8-6.1 Ta, 4.9-5.1 Al, 1.3-1.4 Ti, 0.11-0.15 Si, 0.11-0.15 Hf, 200-750 ppm C, 50-400 ppm B, remainder nickel and unavoidable impurities.

3. The protective tube as claimed in claim 1, wherein the single-crystal nickel-based superalloy has the following chemical composition (in % by weight): 7.7 Cr, 5.1 Co, 2.0 Mo, 7.8 W, 5.8 Ta, 5.0 Al, 1.4 Ti, 0.12 Si, 0.12 Hf, 200 ppm C, 50 ppm B, remainder nickel and unavoidable impurities.

4. A thermocouple assembly comprising:
a protective tube according to claim 1; and
a thermocouple positioned in the protective tube.
